(19) United States
(12) Patent Application Publication
(10) Pub. No.: US 2018/0068451 A1
(43) Pub. Date: Mar. 8, 2018

(54) SYSTEMS AND METHODS FOR CREATING A CINEMAGRAPH

(71) Applicant: QUALCOMM Incorporated, San Diego, CA (US)

(72) Inventors: Adrian Leung, Richmond Hill (CA); Darren Gnanapragasam, Aurora (CA); Alireza Shoa Hassani Lashdan, Burlington (CA)

(21) Appl. No.: 15/260,160

(22) Filed: Sep. 8, 2016

(51) Int. Cl. G06T 7/00; G06T 7/20

(52) U.S. Cl. CPC G06T 7/0081; G06T 2207/10016; G06T 7/2006

(57) ABSTRACT

A method for generating a cinemagraph is described. The method includes determining optical flow information for a frame sequence. The method also includes performing image stabilization using the optical flow information to produce a stabilized frame sequence. The method further includes performing object tracking across the frame sequence using motion vector information to determine an object region of interest (ROI) of an object in each frame in the frame sequence. The method additionally includes generating a masking area for each frame in the stabilized frame sequence based on the object ROI for the frame. The method also includes merging the masking areas and the stabilized frame sequence to generate the cinemagraph.

### FIELD OF DISCLOSURE

The present disclosure relates generally to electronic devices. More specifically, the present disclosure relates to systems and methods for creating a cinemagraph.

### BACKGROUND

In the last several decades, the use of electronic devices has become common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform new functions and/or that perform functions faster, more efficiently or with higher quality are often sought after.

Some electronic devices (e.g., cameras, video camcorders, digital cameras, cellular phones, smart phones, computers, televisions, etc.) may be configured to create a cinemagraph. Cinemagraphs are still photographs where one or more parts of the image have repeated motion. A cinemagraph may form a video clip that gives the appearance of an animated (or live) photograph. A cinemagraph may be created from a sequence of image frames. One current solution to produce a cinemagraph is using a layered mask approach, which is a manual and cumbersome process. As can be observed from this discussion, systems and methods that improve creating a cinemagraph may be beneficial.

### SUMMARY

A method for generating a cinemagraph is described. The method includes determining optical flow information for a frame sequence. The method also includes performing image stabilization using the optical flow information to produce a stabilized frame sequence. The method further includes performing object tracking across the frame sequence using motion vector information to determine an object region of interest (ROI) of an object in each frame in the frame sequence. The method additionally includes generating a masking area for each frame in the stabilized frame sequence based on the object ROI for the frame. The method also includes merging the masking areas and the stabilized frame sequence to generate the cinemagraph.

The masking area of a given frame may be determined by a reference frame object ROI and a current frame object ROI. The method may also include determining the reference frame object ROI based on the object tracking.

The method may also include segmenting the object ROIs using the motion vector information to only include an area that the object occupies. The method may also include aligning the object ROIs with the stabilized frame sequence.

A masking area for a current frame may remove the object from the current frame and may display the object from a reference frame. The object that is tracked may become a static area of the cinemagraph.

A masking area may include area of a current frame outside a reference frame object ROI and a current frame object ROI. The masking area may display the reference frame with the exception of the reference frame object ROI and the current frame object ROI such that the object that is tracked becomes a moving area of the cinemagraph.

An electronic device configured for generating a cinemagraph is also described. The electronic device includes a processor, memory in communication with the processor and instructions stored in the memory. The instructions are executable by the processor to determine optical flow information for a frame sequence. The instructions are also executable to perform image stabilization using the optical flow information to produce a stabilized frame sequence. The instructions are further executable to perform object tracking across the frame sequence using motion vector information to determine an object ROI of an object in each frame in the frame sequence. The instructions are additionally executable to generate a masking area for each frame in the stabilized frame sequence based on the object ROI for the frame. The instructions are also executable to merge the masking areas and the stabilized frame sequence to generate the cinemagraph.

A computer-program product for generating a cinemagraph is also described. The computer-program product includes a non-transitory tangible computer-readable medium having instructions thereon. The instructions include code for causing an electronic device to determine optical flow information for a frame sequence. The instructions also include code for causing the electronic device to perform image stabilization using the optical flow information to produce a stabilized frame sequence. The instructions further include code for causing the electronic device to perform object tracking across the frame sequence using motion vector information to determine an object ROI of an object in each frame in the frame sequence. The instructions additionally include code for causing the electronic device to generate a masking area for each frame in the stabilized frame sequence based on the object ROI for the frame. The instructions also include code for causing the electronic device to merge the masking areas and the stabilized frame sequence to generate the cinemagraph.

### BRIEF DESCRIPTION OF THE DRAWINGS

FIG. 1 is a block diagram illustrating an electronic device configured to create a cinemagraph;

FIG. 2 is a block diagram illustrating another configuration of an electronic device configured to create a cinemagraph;

FIG. 3 is a flow diagram illustrating a method for creating a cinemagraph;

FIG. 4 is an example illustrating an approach to cinemagraph generation using a layered mask approach;

FIG. 5 is an example illustrating an approach to cinemagraph generation according to the described systems and methods;

FIG. 6 is an example illustrating another approach to cinemagraph generation according to the described systems and methods;

FIG. 7 is a flow diagram illustrating a method for creating a cinemagraph; and

FIG. 8 illustrates certain components that may be included within an electronic device.

### DETAILED DESCRIPTION

Cinemagraphs are still photographs where one or more parts of the image have repeated motion. A cinemagraph may form a video clip that gives the appearance of an animated (or live) photograph. In current approaches, this requires the use of offline photo/video editing tools as well as a relatively well-thought-out plan for what to capture.

One current solution to produce a cinemagraph is using a layered mask approach. Given a frame sequence (e.g., photo or video sequence), one of the frames in the sequence is chosen as a still image (also referred to as a reference frame or reference layer). This frame is opaque in that the bottom layer is not visible. A mask region in the frame is then selected by the user so that the pixels from the bottom layer are shown. The layers of the frames are merged together and the frame sequence is converted to an animated graphics interchange format (GIF) image or video so that it is repeated or mirrored to be in a continuous loop.

In the current approach, the chosen mask is static across each frame. Furthermore, the current approach has a lack of camera shake removal. To generate a coherent cinemagraph, all images in the sequence need to be aligned in order to create the appearance of a still photo that has logical motion components. Another issue with current approaches is that drawing the masking area, using a smartphone touchscreen, for example, can be cumbersome to accurately create the desired mask.

In the systems and methods described herein, instead of using a static masking area that is drawn by the user, an electronic device may create a cinemagraph using automated computer vision techniques. Camera shake may be minimized by using optical flow information to negate global motion. Masking areas may be generated based on object tracking results. Systems and methods for creating a cinemagraph are explained in greater detail below.

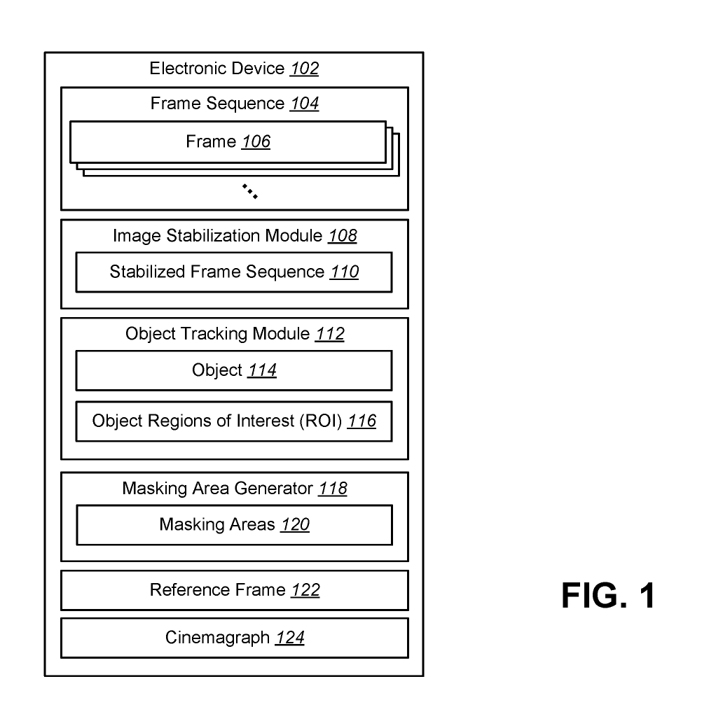

FIG. 1 is a block diagram illustrating an electronic device 102 configured to create a cinemagraph 124. The electronic device 102 may also be referred to as a wireless communication device, a mobile device, mobile station, subscriber station, client, client station, user equipment (UE), remote station, access terminal, mobile terminal, terminal, user terminal, subscriber unit, etc. Examples of electronic devices include laptop or desktop computers, cellular phones, smart phones, wireless modems, e-readers, tablet devices, gaming systems, robots, aircraft, unmanned aerial vehicles (UAVs), automobiles, etc. Some of these devices may operate in accordance with one or more industry standards.

Cinemagraphs 124 are still photographs where one or more parts of the image have repeated motion. A cinemagraph 124 may form a video clip that gives the appearance of an animated (or live) photograph. In other words, in a cinemagraph 124, there is motion in certain parts of the photo so that it seems like the photo is alive, although all the other objects around what is live are static. For example, a cinemagraph 124 may include a child playing with a dog. In one version of the cinemagraph 124, the child may be still and the dog may be in motion. In another version of the cinemagraph 124, the child may be in motion and the dog may be still. In another example of a cinemagraph 124, a person may stand in a field of grass in which only a portion of the grass sways in the wind and everything else is static.

Motion in a cinemagraph 124 is generated using a frame sequence 104. As used herein, a frame sequence 104 may be sequential photos or video frames. A frame sequence 104 may include a plurality of frames 106. Each frame 106 may be a separate digital image in the frame sequence 104.

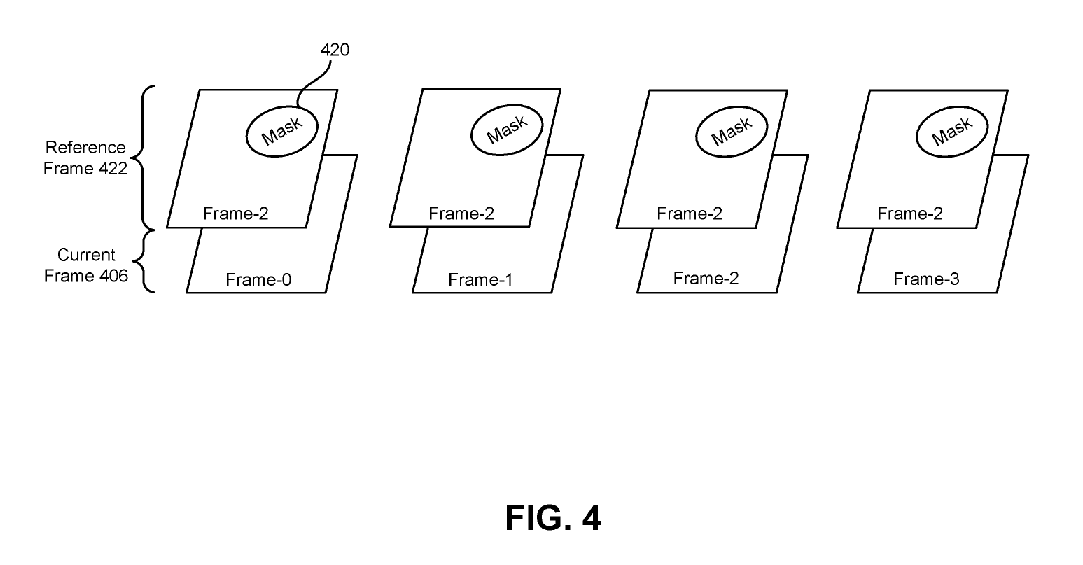

A current mobile solution (i.e., implemented on a mobile device) to produce a cinemagraph 124 uses a layered mask approach. An example of this approach is described in connection with FIG. 4. Given a frame sequence 104, one of the frames 106 in the frame sequence 104 is chosen as the still image of the cinemagraph 124. This still image is opaque in that the bottom layer (i.e., the other frames 106 in the frame sequence 104) is not visible. A mask region in the still image is then selected by the user so that the pixels from the bottom layer are shown. The layers of the frames 106 are merged together and the frame sequence 104 is converted to an animated GIF or video so that it is repeated or mirrored to be in a continuous loop.

However, in this approach, the chosen mask is static across each frame 106. Furthermore, this approach lacks camera shake removal. To generate a coherent cinemagraph 124, all images in the frame sequence 104 need to be aligned in order to have a photograph look and feel. This may require the use of a tripod, but everyday smartphone users do not carry one around. Another issue with current approaches is that drawing the masking area, using a smartphone touchscreen, is cumbersome to accurately create the desired mask on a mobile device.

The systems and methods described herein provide for creating a cinemagraph 124 using automated computer vision techniques. This may lift some of the restrictions of the current approaches and produce similar or superior results.

The electronic device 102 may acquire a frame sequence 104. In an implementation, an electronic device 102, such as a smartphone or tablet computer, for example, may include a camera (not shown). The camera may include an image sensor and an optical system (e.g., lenses) that focuses images of objects that are located within the field of view of the optical system onto the image sensor. The camera may be configured to capture digital images.

Although the present systems and methods are described in terms of a captured frame sequence 104, the techniques discussed herein may be used on any digital image sequence. Therefore, the terms video frame and digital image may be used interchangeably herein. Likewise, in certain implementations the electronic device 102 may not include a camera and optical system, but may receive or utilize a stored frame sequence 104.

The electronic device 102 may also include a camera software application and a display screen (not shown). When the camera application is running, images of objects that are located within the field of view of the optical system camera may be recorded by the image sensor. The images that are being recorded by the image sensor may be displayed on the display screen. These images may be displayed in rapid succession at a relatively high frame rate so that, at any given moment in time, the objects that are located within the field of view of the camera are displayed on the display screen.

Upon acquiring a frame sequence 104, one of the frames 106 in the frame sequence 104 may be chosen as a reference frame 122. This reference frame 122 (also referred to as a reference layer) may become the still image of the cinemagraph 124. In an implementation, the user may view the frames 106 in the frame sequence 104 and select a frame 106 as the reference frame 122. In another implementation, the electronic device 102 may automatically select the reference frame 122. In yet another implementation, the first frame 106 in the frame sequence 104 may be selected as the reference frame 122.

The electronic device 102 may include an image stabilization module 108. Camera shake is minimized by using optical flow information to negate global motion. As an example, corner features with little to no local motion are selected and any motion estimation algorithm (e.g., Lucas-Kanade optical flow or encoder-based block matching) may be used to estimate the displacement of these points between the reference frame 122 and any other frame 106 in the frame sequence 104. A homography transformation may then be computed based on the displacement of the corner features being tracked between the reference frame 122 and the other frame 106 being analyzed. When the transformation is applied to the other frame 106, it will be warped to achieve alignment to the reference frame 122. Because corner features with little to no local motion were selected, the global motion is thus negated as a result of the warping transformation. The image stabilization module 108 may produce a stabilized frame sequence 110.

In an implementation, the image stabilization module 108 may use motion vectors to perform image stabilization. The image stabilization module 108 may identify corners with little local motion in a frame 106 (e.g., the reference frame 122). Then, across the frame sequence 104, the image stabilization module 108 may find out how far the corners deviate from the corners in the reference frame 122. This involves a motion vector indicating where that corner moved on whichever frame 106 is being analyzed. The motion vector information may include the actual motion value of the pixels.

An example to find the motion vector information of the corners that were selected is to use a block matching algorithm for the purpose of motion estimation. Image blocks from the frame 106 being analyzed are compared to the blocks from the reference frame 122 which contain the corners. An appropriate match is one in which the sum of absolute differences (SAD) between the two blocks is minimized.

The electronic device 102 may also include an object tracking module 112. In an implementation, the electronic device 102 may perform object recognition to automatically select an object 114 for tracking. For example, the electronic device 102 may detect people and/or other objects for tracking.

In another implementation, a user may manually select one or more objects 114 in a frame 106. A user interface (not shown) of the camera application may permit one or more objects 114 that are being displayed on the display screen to be selected. In one configuration, the display is a touchscreen that receives input from physical touch, e.g., by a finger, stylus or other tool. The touchscreen may receive touch input defining a target object 114. A user-selected object 114 may be further detected in any suitable way. For example, facial recognition, person recognition, boundary detection, etc., may be used to identify an object 114 in the vicinity of the user selection.

The object tracking module 112 may use object tracking techniques to track the object 114 across the frame sequence 104. In an implementation, the object 114 may be tracked using motion vector information. As with image stabilization, for object tracking, the object tracking module 112 may take the corners of the tracked object 114. The object tracking module 112 may then determine where the object 114 moves on every subsequent frame 106 thereafter, which again is using motion vectors.

The object tracking module 112 may produce one or more object regions of interest (ROIs) 116 for each frame 106. An object ROI 116 may be a bounding area that surrounds the object 114 in a given frame 106. The object ROI 116 may have a rectangular (e.g., box) shape or another shape (e.g., circle, oval, square, etc.). The object ROI 116 may encompass the boundaries of the object 114 while minimizing the non-object area that is included.

When there is a single object 114 that is being tracked, a frame 106 may include a single object ROI 116. When multiple objects 116 are tracked, a corresponding number of object ROIs 116 may be produced per frame 106.

The object tracking module 112 may apply the transform generated during the image stabilization operation to the object ROIs 116. Therefore, the object ROIs 116 may be aligned with the stabilized frame sequence 110.

The electronic device 102 may also include a masking area generator 118. The object tracking will provide one or more object ROIs 116 on each frame 106 that may be used to determine a masking area 120. The masking area generator 118 may generate a masking area 120 that is determined by a reference frame object ROI 116 and a current frame object ROI 116.

In one approach, the object 114 that is tracked becomes a static area of the cinemagraph 124. In this approach, the masking area 120 includes the reference frame object ROI 116 and the current frame object ROI 116. The masking area 120 for a current frame 106 removes the object 114 from the current frame 106 and displays the object 114 from the reference frame 122.

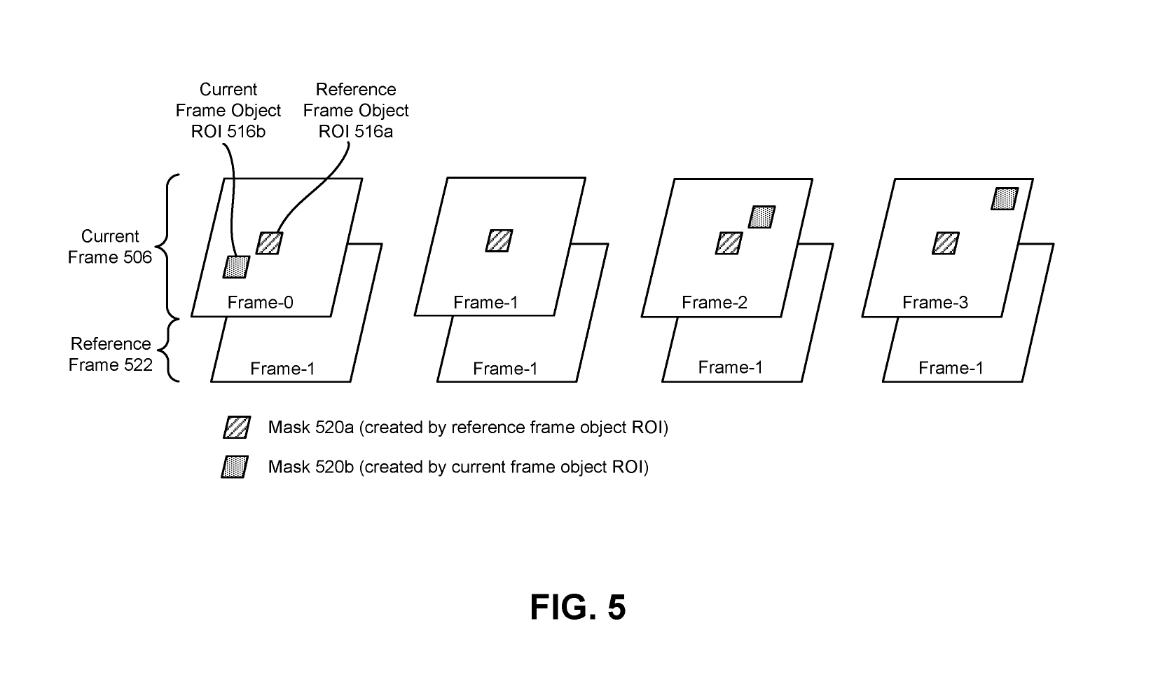

This approach uses a layered approach to create a cinemagraph 124 but uses the object ROIs 116 as the masking areas 120 to display the bottom layer content. An example of this approach is described in connection with FIG. 5. The masking area 120 for each frame 106 may be generated by using the object ROI 116 result from the reference frame 122 in addition to the object ROI 116 result of the current frame 106. Therefore, the masking area 120 for a given frame 106 may include two regions (i.e., the reference frame object ROI 116 and the current frame object ROI 116).

The masking areas 120 dynamically change and are extracted by the object tracking results. This approach removes the object 114 from the current frame 106 and inserts the object 114 from the reference frame 122 to make the object 114 appear still throughout the frame sequence 104. By analyzing the optical flow and object tracking results, the electronic device 102 may generate a cinemagraph 124 where the tracked objects 114 end up being the still parts of the photo.

For further improved quality, instead of using the object ROI 116 result (e.g., a rectangular shape) as the masking areas 120, the selected object 114 can be segmented from the object ROI 116 using motion vector information. The segmented shape may follow the boundaries of the object 114 in the object ROI 116. The segmented shape is then used instead for masking area 120 generation. In this implementation, the masking area 120 is based on segmenting the motion vectors of the image pixels.

Segmentation may be especially useful when there is a lot of motion in the background. Therefore, in an implementation, segmentation may be selectively performed when background motion is detected. In another implementation, segmentation may be initiated by user-choice. In yet another implementation, segmentation may be performed in all cases.

It should be noted that because the electronic device 102 performs motion estimation and acquires the motion vector information, this motion vector information may also be used for the segmentation. Therefore, the electronic device 102 does not need to start from scratch with the motion estimation process for segmentation.

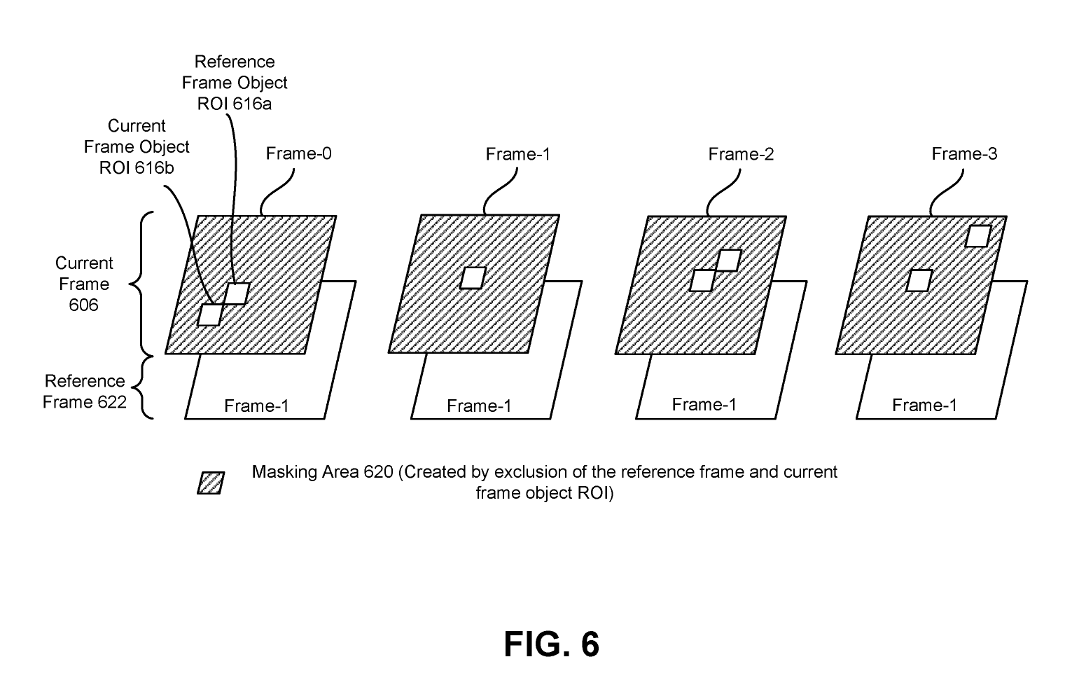

In another approach, the objects 114 that are tracked end up being the only living (i.e., moving) parts of the cinemagraph 124. In this approach, the masking areas 120 may be generated using the area of a frame 106 outside of the object ROI(s) 116. In other words, the masking areas 120 may exclude the reference frame object ROI 116 and the current frame object ROI 116. An example of this approach is described in connection with FIG. 6.

Upon generating the masking areas 120, each frame's 106 layers (e.g., the reference frame 122, the current frame 106 and masking area 120) may be blended together to a single frame. This process may be performed for each frame 106 in the frame sequence 104. The merged frame sequence may be converted to an animated image or video file (e.g., GIF) that loops infinitely in sequence or is mirrored to produce the final cinemagraph 124.

The systems and methods described herein use a motion estimation-centric approach to generating a cinemagraph 124. The motion vector information is used to complete each of the following functions: image stabilization (e.g., camera shake removal), object tracking and segmentation. Another approach uses motion estimation for the camera shake removal but uses local motion detection methods (and not motion vectors) for segmentation. This approach then refines these segments further using various approaches (one example includes an iterative “force” decision algorithm). In other words, this other approach segments local motion and implicitly tracks it with refinement, whereas the systems and methods described herein perform explicit object tracking and then segmentation based on the motion vector information.

An advantage of this solution includes leveraging specialized hardware on mobile system on chip (SOC) solutions (e.g., optical flow engines and digital signal processors (DSPs)). The described systems and methods also provide the user with an alternate and automated approach to generate a cinemagraph 124. A user may use a mobile device to create a cinemagraph 124 without having to awkwardly draw the masking areas 120.

An example use case for the described systems and methods is as an added feature for camera burst mode on smartphones. Burst mode captures high resolution images at around 20 Hz. A sequence of 20 frames at 20 Hz is more than enough to capture interesting motion when combined as a cinemagraph 124. People in photos are usually posing, which presents an opportunity for “freezing” them while leaving the subtle motion around them.

Another example use case for the described systems and methods is as a companion to video. For example, in some smartphones, a short amount of video is captured while the user takes a photo. This situation is great for generating a cinemagraph as companion media. In these situations, subjects may be posing and the electronic device 102 does not have to deal with significant global motion other than camera shake.

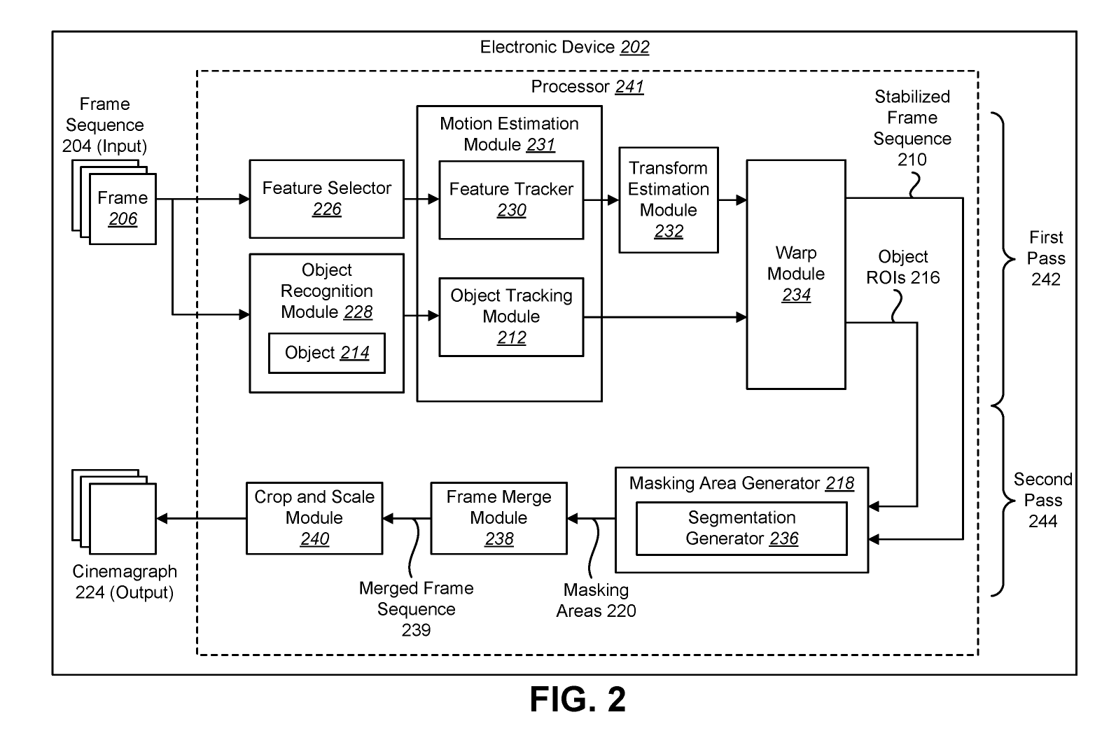

FIG. 2 is a block diagram illustrating another configuration of an electronic device 202 configured to create a cinemagraph 224. In a first pass 242, the electronic device 202 may receive a frame sequence 204 as input. The frame sequence 204 may be captured by a camera, which may or may not be part of the electronic device 202. In the first pass 242, the electronic device 202 may stabilize the frame sequence 204 and may perform object tracking.

A feature selector 226 may receive the frame sequence 204. The feature selector 226 may select corners within a frame 206 (e.g., in the frame sequence 204 with little local motion. The feature selector 226 may provide the selected corners to a feature tracker 230 in a motion estimation module 231.

An object recognition module 228 may detect an object 214 in a frame 206 of the frame sequence 204 to be tracked. This object 214 may include faces, people or other objects depending on the configuration of the object recognition module 228. In another implementation, a user may select an area in a frame 206 and the object recognition module 228 may identify an object 214 in that area. The object recognition module 228 may provide the selected object 214 to an object tracking module 212 in the motion estimation module 231.

The object recognition module 228 may select one or more objects 214. For example, the number of tracked objects 214 may depend on how many people a user wants to track. It could be multiple, or just one. That would depend on either a user selecting an object 214, or using some other algorithm where the object recognition module 228 detects any people in the scene, for example.

The motion estimation module 231 may use computer vision techniques to stabilize the frame sequence 204 and track the selected object 214. The feature tracker 230 may track the selected corners using optical flow. This may be based on motion vector information generated across the frame sequence 204. The feature tracker 230 may track the selected corners across the frame sequence 204 to determine how much they deviate from the first frame 206 (i.e., the frame 206 where the feature selector 226 selected the corners) or the reference frame 122.

The feature tracker 230 may provide the motion vector information for the corners to a transform estimation module 232. By determining how far the corners move away, the transform estimation module 232 may determine a transform to warp all the subsequent frames 206 in the frame sequence 204 to align with the reference frame 122. Therefore, the transform estimation module 232 may determine how much each frame 206 should be stretched (i.e., warped) to stabilize the image frame 204. A warp module 234 may apply the transform to the frame sequence 204 to produce a stabilized frame sequence 210.

The object tracking module 212 may receive the selected one or more objects 214 and perform object tracking of the one or more objects 214 in the frame sequence 204. The object tracking may be performed using motion vector information. The object tracking module 212 may determine an object ROI 216, which is the general area of the object 214 within a given frame 206. In an implementation, the object ROI 216 may be a rectangle that bounds the object 214 in a frame 206.

The object tracking module 212 may provide the object ROIs 216 to the warp module 234, which applies the transform to align the object ROIs 216 to the stabilized frame sequence 210. In other words, the object tracking module 212 may generate a rectangular window (i.e., object ROI 216) around the tracked object 214. The warp module 234 then warps the rectangular window accordingly, so that it will end up matching the stabilized frame sequence 210.

In an implementation, the object tracking may be used to make a selected object 214 static throughout the frame sequence 204. For example, a user may want to select a person that is jumping up and down. Throughout that whole frame sequence 204, the object tracking module 212 may track that person. For each frame 206, the object tracking module 212 may determine the general area (i.e., object ROI 216) where the person is. These object ROIs 216 may then be used to cause the object 214 to appear static in the frame sequence 204.

In the second pass 244, the electronic device 202 may generate masking areas 220 based on the object ROIs 216 that were determined from the object tracking. A masking area generator 218 may receive the stabilized frame sequence 210 and the object ROIs 216. The masking area generator 218 may generate a masking area 220 for each frame 206 using a current frame object ROI 216 and a reference frame ROI 216. As described in connection with FIG. 1, the reference frame 122 may be a frame 206 that is selected as the static image in the cinemagraph 224.

For each frame 206 in the stabilized frame sequence 210, the masking area generator 218 may generate a masking area 220 based on the current frame object ROI 216 and the reference frame ROI 216. In an implementation, the masking area 220 is the combination of the current frame object ROI 216 and the reference frame ROI 216. In another implementation, the masking area 220 is all of a current frame 206 area outside the current frame object ROI 216 and the reference frame ROI 216.

In an implementation, the masking area generator 218 may include a segmentation generator 236. The segmentation generator 236 may segment an object 214 in an object ROI 216 (i.e., the current frame object ROI 216 and the reference frame ROI 216) of a frame 206 using the motion vector information generated by the motion estimation module 231. This segmentation masks only the area that the object occupies. In other words, the segmentation generator 236 refines the rectangular object ROI 216 to follow the boundary of the object 214. The segmented objects are then used to generate the masking area 220. The segmentation may produce better masking area 220 results, especially when there is motion in the background of the image frame 204.

A frame merge module 238 may receive the masking area 220 and the stabilized frame sequence 210. For each frame 206 in the stabilized frame sequence 210, the frame merge module 238 may layer the reference frame 122, the current frame 206 and the masking areas 220. The masking areas 220 may allow the pixels from the bottom layer to show through the top layer. For each frame 206 in the stabilized frame sequence 210, the frame merge module 238 may merge the reference frame 122, the current frame 206 and the masking areas 220 to produce a single merged frame.

In an implementation, the reference frame 122 is the bottom layer and the current frame 206 is the top layer. In this implementation, the pixels in the masking areas 220 of the current frame 206 will be replaced with the corresponding pixels in the reference frame 122. This implementation results in the object 214 within the masking area 220 being static and the area outside the masking area 220 may be in motion.

In another implementation, the reference frame 122 may be on top and the current frame is on the bottom. The result of this implementation is the object 214 within the masking area 220 may be in motion and the area outside the masking area 220 is static.

A crop and scale module 240 may receive the merged frame sequence 239. The crop and scale module 240 may remove any outside borders. Because of the warp, some areas may end up outside of a frame 206 in the merged frame sequence 239. The crop and scale module 240 may determine how much to crop and/or scale the merged frame sequence 239 to remove any artifacts on the outside. This crop and scale operation may be based on the transform generated by the transform estimation module 232. The output of the crop and scale module 240 is the final cinemagraph 224.

As illustrated in FIG. 2, one or more of the illustrated components may be optionally implemented by a processor 241. In some configurations, different processors may be used to implement different components (e.g., one processor may implement the object tracking module 212, another processor may be used to implement the feature tracker 230, another processor may be used to implement the masking area generator 218 and so forth).

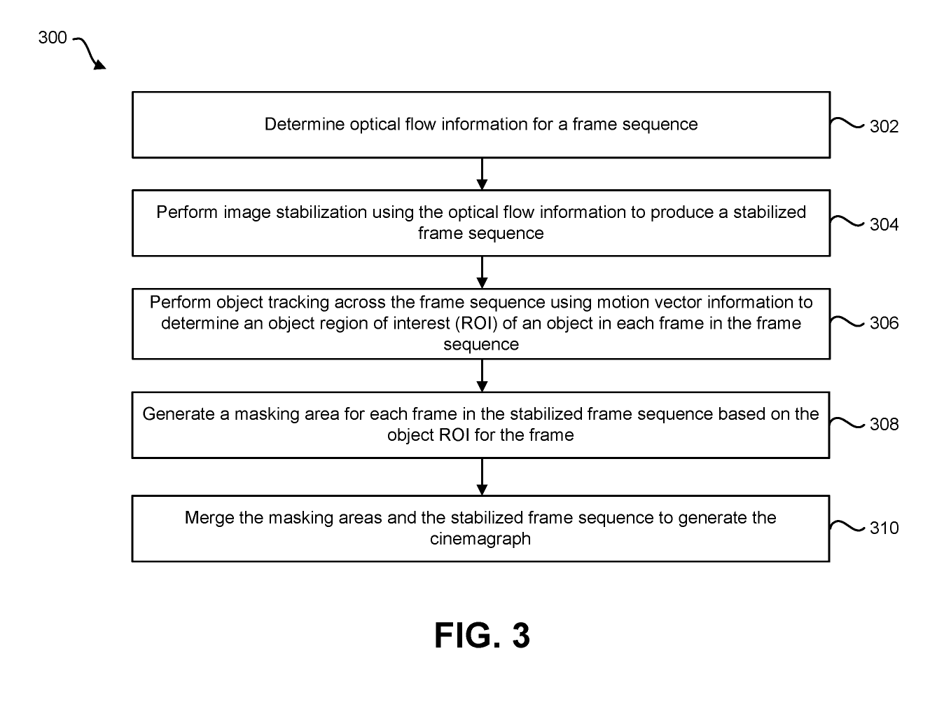

FIG. 3 is a flow diagram illustrating a method 300 for creating a cinemagraph 224. The method 300 may be implemented by an electronic device 202 as depicted in FIG. 2. In some implementations, the method 300 may be implemented in part by a processor, e.g., processor 241, in the electronic device 202.

With reference to FIG. 2 and FIG. 3, the electronic device 202 may determine optical flow information for a frame sequence 204. For example, the electronic device 202 may perform an optical flow analysis. Corner features with little to no local motion may be selected and a motion estimation algorithm (e.g., Lucas-Kanade optical flow or encoder-based block matching) may be used to estimate the displacement of these points between a reference frame 122 and any other frame 206 in the frame sequence 204.

The electronic device 202 may perform 304 image stabilization using the optical flow information to produce a stabilized frame sequence 210. For example, the electronic device 202 may generate a transform that aligns the frames 206 in the frame sequence 204. A transformation may be computed based on the displacement of the corner features being tracked between the reference frame 122 and another frame 206 being analyzed. When the transformation is applied to the other frame 206, it will be warped to achieve alignment to the reference frame 122. Because corner features with little to no local motion were selected, the global motion is negated as a result of the warping transformation.

The electronic device 202 may perform 306 object tracking across the frame sequence 204 using motion vector information to determine an object region of interest (ROI) 216 of an object 214 in each frame 206 in the frame sequence 204. For example, an object 214 may be selected for tracking. This selection may be by user-selection or by an object recognition operation. The electronic device 202 may track the object 214 in each frame 206 using motion vector information.

For each frame 206, the electronic device 202 may determine an object ROI 216. The object ROI 216 may be a rectangle that bounds the object 216 in a given frame 206. Alternatively, the object ROI 216 may be another shape (e.g., oval) that bounds the tracked object 214.

The electronic device 202 may generate 308 a masking area 220 for each frame 206 in the stabilized frame sequence 210 based on the object ROI 216 for the frame 206. The electronic device 202 may align the object ROIs 216 with the stabilized frame sequence 210. This may be accomplished by applying the transform used for image stabilization to the object ROIs 216.

The masking area 220 of a given frame 206 may be determined by a reference frame object ROI 216 and a current frame object ROI 216. The reference frame 122 may be selected from the frame sequence 204. This reference frame 122 may be the static image of the cinemagraph 224. The electronic device 202 may determine the reference frame object ROI 216 based on the object tracking.

The electronic device 202 may merge 310 the masking areas 220 and the stabilized frame sequence 210 to generate the cinemagraph 224. For each frame 206 in the stabilized frame sequence 210, the electronic device 202 may layer the reference frame 122, the current frame 206 and the masking areas 220. The masking areas 220 may allow the pixels from the bottom layer to show through the top layer. For each frame 206 in the stabilized frame sequence 210, the electronic device 202 may merge 310 the reference frame 122, the current frame 206 and the masking areas 220 to produce a single merged frame.

In an implementation, a masking area 220 for a current frame 206 removes the object 214 from the current frame 206 and displays the object 214 from the reference frame 122. The object 214 that is tracked becomes a static area of the cinemagraph 224. An example of this implementation is described in connection with FIG. 5.

In another implementation, a masking area 220 comprises the area of a current frame 206 outside the reference frame object ROI 216 and the current frame object ROI 216. In this implementation, the masking area 220 displays the reference frame 122 with the exception of the reference frame object ROI 216 and the current frame object ROI 216 such that the object 214 that is tracked becomes a moving area of the cinemagraph 224. An example of this implementation is described in connection with FIG. 6.

FIG. 4 is an example illustrating an approach to cinemagraph 124 generation using a layered mask approach. In this approach, there are essentially two frame layers. For a given frame sequence 104 (e.g., image burst or video sequence), one of the frames 406 in the frame sequence 104 is chosen as the static reference frame 422. In this example, the reference frame 422 is Frame-2. The reference frame 422 is placed as the top layer of all frames 406 in the frame sequence 104.

Underneath the top layer (i.e., the reference frame 422) is a current frame 406 from the frame sequence 104. To generate motion, a static masking area 420 is drawn on screen. The masking area 420 is statically positioned through the whole frame sequence 104.

The masking area 420 is selected to show the image from the bottom layer rather than the top layer. In this example, the area in the ellipse is the masking area 420 that will display pixels from the bottom layer rather than the top layer. The masking area 420, essentially, is a hole through the top layer so that the image underneath shows through. Looking at the frames 406 in sequence creates motion where the masking area 420 is.

There are two drawbacks to this approach. The first one is that there is no camera shake removal. If a mobile device is capturing the frame sequence 104, a user is likely holding the mobile device by hand. In this case, there is going to be some camera shake. The problem with the camera shake is that if the masking area 420 is not drawn properly, the motion can sometimes be very nonsensical. For example, the object 114 might only be partially shown when the entire object should be shown. Also, the object 114 may shake around when it really should be in one place.

The second problem with this approach is that drawing the masking area 420 may be very cumbersome. For example, on a mobile device, a user may need to go through several iterations using their finger to draw the masking area 420 and then picking an eraser tool to refine the masking area 420 a little more. That process is very cumbersome. As can be seen by this discussion, benefits may be realized using the systems and methods for creating a cinemagraph 124 as described herein.

FIG. 5 is an example illustrating an approach to cinemagraph 124 generation according to the described systems and methods. This example includes a frame sequence 104. This approach uses a layered approach to create a cinemagraph 124. However, as opposed to the approach described in connection with FIG. 4, this approach uses the object ROIs 516 determined by object tracking as the masking areas 520 to display the bottom layer content. In this example, the tracked objects 114 end up being the still parts of the cinemagraph 124.

In this approach, the current frame 506 of the frame sequence 104 is the top layer and the reference frame 522 is the static image on the bottom layer. In this example, Frame-1 is the reference frame 522.

The masking area 520 for a given frame is a combination of the mask 520a created by the reference frame object ROI 516a and the mask 520b created by the current frame object ROI 516b. It should be noted that the object ROIs 516 are determined by tracking an object 114 across the frame sequence 104. The reference frame object ROI 516a corresponds to the object 114 location in Frame-1. That is why there is only one masking area 520 for Frame-1. For the other current frames 506, the current frame ROI 516b and the reference frame ROI 516b are offset.

In Frame-0, the current frame ROI 516b shows where the object 114 was originally. As the object 114 moves across, the current frame ROI 516b (and corresponding mask 520b) is moving from bottom left to top right.

The masking area 520 displays what is on the reference frame 522 (Frame-1). The mask 520b created by the current frame object ROI 516b will remove the object 114 from the current frame 506. This is because in the reference frame 522 (Frame-1) the object 114 was not in that area. The mask 520a created by the reference frame object ROI 516a shows the object 114 where it is on Frame-1. This ensures that the object 114 is in one static position. Motion outside the masking area 520 is displayed.

In another implementation, the reference frame 522 may be placed on the top layer and the current frame 506 may be the bottom layer. This implementation results in the inverse of the example described above. Everything outside the masking area 520 is now static and everything inside the masking area 520 may be in motion.

FIG. 6 is an example illustrating another approach to cinemagraph 124 generation according to the described systems and methods. This example includes a frame sequence 104. This approach uses a layered approach similar to the approach described in connection with FIG. 5. In this approach, the current frame 606 of the frame sequence 104 is the top layer and the reference frame 622 is the static image on the bottom layer. In this example, Frame-1 is the reference frame 622.

This approach generates a masking area 620 using the area outside of the object ROI(s) 616. The objects 114 that are tracked end up being the only living parts of the cinemagraph 124.

This approach uses the object ROIs 616 determined by the object tracking as the masking areas 620 to display the bottom layer content. The masking area 620 for a given frame 606 is generated by excluding the reference frame object ROI 616a and the current frame object ROI 616b.

As with the example described in connection with FIG. 5, the masking area 620 displays what is on the reference frame 622 (Frame-1). However, the current frame object ROI 616b will show the object 114 in the current frame 606 and the reference frame object ROI 616a will remove the object 114 from where it is on Frame-1. This ensures that the object 114 is in motion and the non-object areas are static.

In another implementation, the reference frame 622 may be placed on the top layer and the current frame 606 may be the bottom layer. This implementation results in the inverse of the example described above. Everything outside the masking area 620 is now in motion and everything inside the masking area 620 is static.

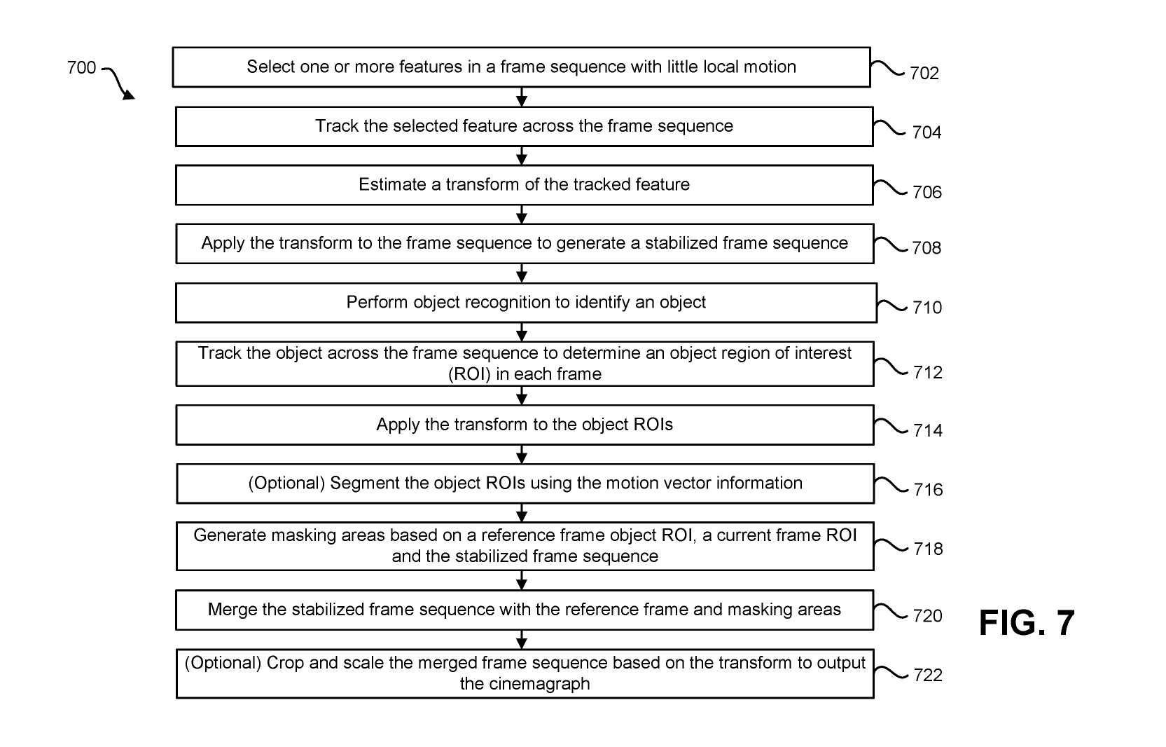

FIG. 7 is a flow diagram illustrating a method 700 for creating a cinemagraph 224. The method 700 may be implemented by an electronic device 202 as depicted in FIG. 2. In some implementations, the method 700 may be implemented in part by a processor, e.g., processor 241, in the electronic device 202.

With reference to FIG. 2 and FIG. 7, the electronic device 202 may acquire a frame sequence 204. For example, the electronic device 202 may capture a video sequence or image burst. A frame 206 in the frame sequence 204 may be selected as a reference frame 122. The reference frame 122 may be the still image of the cinemagraph 224. For example, a user may indicate one of the frames 206 as the reference frame 122.

The electronic device 202 may select 702 one or more features in the frame sequence 204 with little local motion. For example, the electronic device 202 may select corners in the reference frame 122 that have little local motion.

The electronic device 202 may track 704 the selected feature(s) across the frame sequence 204. For example, the electronic device 202 may track the selected corners using optical flow. This may be based on motion vector information generated across the frame sequence 204. The electronic device 202 may track the selected corners across the frame sequence 204 to determine how much they deviate from the reference frame 122.

The electronic device 202 may estimate 706 a transform of the tracked feature. By determining how far the corners move away from the reference frame 122, the electronic device 202 may determine a transform that aligns the other frames 206 in the frame sequence 204 with the reference frame 122. The transform may provide how much each frame 206 should be stretched to stabilize the image frame 204. The electronic device 202 may apply 708 the transform to generate a stabilized frame sequence 210.

The electronic device 202 may perform 710 object recognition to identify an object for tracking. In an implementation, the electronic device 202 may detect an object 214 in a frame 206 of the frame sequence 204. This object recognition may include facial recognition, people recognition or other objects. In another implementation, a user may select an area in a frame 206. The electronic device 202 may then detect the object 214 in any suitable way. For example, facial recognition, person recognition, boundary detection, etc., may be used to identify an object 214 in the vicinity of the user selection.

The electronic device 202 may track 712 the object 214 across the frame sequence 204 to determine an object ROI 216 in each frame 206. The object tracking may be performed using motion vector information. The electronic device 202 may determine an object ROI 216, which is the general area of the object 214 within a given frame 206. In an implementation, the object ROI 216 may be a rectangle that bounds the object 214 in a frame 206.

The electronic device 202 may apply 714 the transform to the object ROIs 216. This aligns the object ROIs 216 with the stabilized frame sequence 210.

The electronic device 202 may (optionally) segment 716 the object ROIs 216 using the motion vector information. The segmented shape may follow the boundaries of the object 214 in the object ROI 216. After performing segmentation, the object ROIs 216 may only include an area that the object 214 occupies.

The electronic device 202 may generate 718 masking areas 220 based on a reference frame object ROI 216, a current frame object ROI 216 and the stabilized frame sequence 210. In an implementation, the reference frame object ROI 216 and the current frame object ROI 216 are the masking area 220 for a given frame 206. In this implementation, the masking area 220 for a current frame 206 removes the object 214 from the current frame 206 and displays the object 214 from the reference frame 122. The object 214 that is tracked becomes a static area of the cinemagraph 224.

In another implementation, the masking area 220 is the area of a current frame 206 outside the reference frame object ROI 216 and the current frame object ROI 216. The masking area 220, therefore, displays the reference frame 122 with the exception of the reference frame object ROI 216 and the current frame object ROI 216 such that the object 214 that is tracked becomes the moving area of the cinemagraph 224.

The electronic device 202 may merge 720 the stabilized frame sequence 210 with the reference frame 122 and the masking areas 220. For example, the electronic device 202 may layer the reference frame 122 above or below the current frame 206 in the frame sequence 204. The masking area 220 is then placed on top to show the bottom layer through the top layer.

The electronic device 202 may (optionally) crop and scale 722 the merged frame sequence 239 based on the transform to output the cinemagraph 224. The electronic device 202 may crop the merged frame sequence 239 to remove border artifacts caused by the transform. The electronic device 202 may then scale the cropped frame sequence to maintain the same dimensions as the original frame sequence 204.

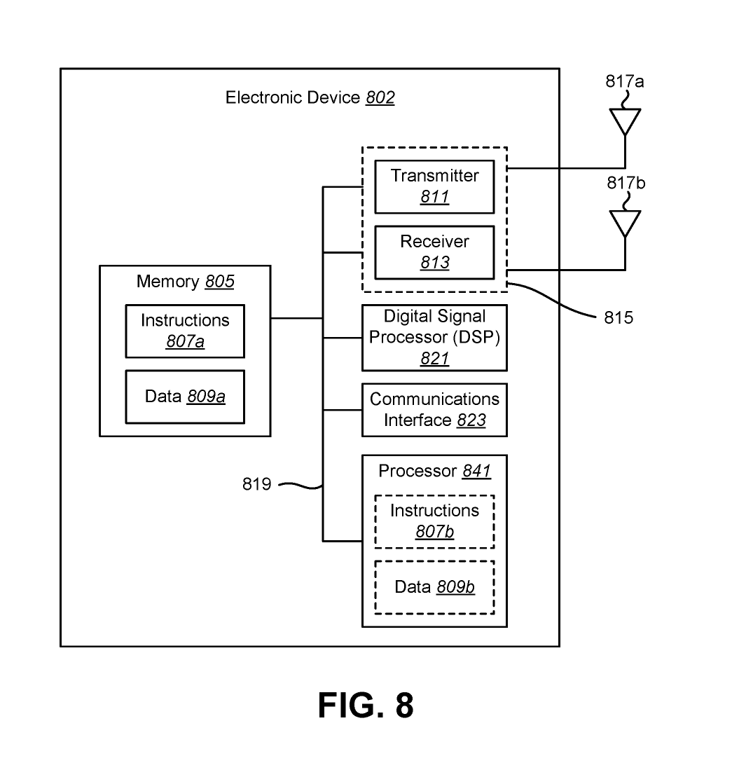

FIG. 8 illustrates certain components that may be included within an electronic device 802. The electronic device 802 may be (or may be included within) a camera, video camcorder, digital camera, cellular phone, smart phone, computer (e.g., desktop computer, laptop computer, etc.), tablet device, media player, television, automobile, personal camera, action camera, surveillance camera, mounted camera, connected camera, robot, gaming console, personal digital assistants (PDA), set-top box, etc.

The electronic device 802 includes a processor 841. The processor 841 may be a general purpose single- or multi-chip microprocessor (e.g., an ARM), a special purpose microprocessor (e.g., a digital signal processor (DSP)), a microcontroller, a programmable gate array, etc. The processor 841 may be referred to as a central processing unit (CPU). Although just a single processor 841 is shown in the electronic device 802, in an alternative configuration, a combination of processors (e.g., an ARM and DSP) could be used.

The electronic device 802 also includes memory 805. The memory 805 may be any electronic component capable of storing electronic information. The memory 805 may be embodied as random access memory (RAM), read-only memory (ROM), magnetic disk storage media, optical storage media, flash memory devices in RAM, on-board memory included with the processor, EPROM memory, EEPROM memory, registers, and so forth, including combinations thereof.

Data 809a and instructions 807a may be stored in the memory 805. The instructions 807a may be executable by the processor 841 to implement one or more of the methods described herein. Executing the instructions 807a may involve the use of the data 809a that is stored in the memory 805. When the processor 841 executes the instructions 807, various portions of the instructions 807b may be loaded onto the processor 841, and various pieces of data 809b may be loaded onto the processor 841.

The electronic device 802 may also include a transmitter 811 and a receiver 813 to allow transmission and reception of signals to and from the electronic device 802. The transmitter 811 and receiver 813 may be collectively referred to as a transceiver 815. One or multiple antennas 817a-b may be electrically coupled to the transceiver 815. The electronic device 802 may also include (not shown) multiple transmitters, multiple receivers, multiple transceivers and/or additional antennas.

The electronic device 802 may include a digital signal processor (DSP) 821. The electronic device 802 may also include a communications interface 823. The communications interface 823 may enable one or more kinds of input and/or output. For example, the communications interface 823 may include one or more ports and/or communication devices for linking other devices to the electronic device 802. Additionally or alternatively, the communications interface 823 may include one or more other interfaces (e.g., touchscreen, keypad, keyboard, microphone, camera, etc.). For example, the communication interface 823 may enable a user to interact with the electronic device 802.

The various components of the electronic device 802 may be coupled together by one or more buses, which may include a power bus, a control signal bus, a status signal bus, a data bus, etc. For the sake of clarity, the various buses are illustrated in FIG. 8 as a bus system 819.

In accordance with the present disclosure, a circuit, in an electronic device, may be adapted to perform image stabilization using optical flow information to negate global motion in a frame sequence to produce a stabilized frame sequence. The same circuit, a different circuit, or a second section of the same or different circuit may be adapted to perform object tracking across the frame sequence using motion vector information to determine an object region of interest (ROI) of an object in each frame in the frame sequence. The same circuit, a different circuit, or a third section of the same or different circuit may be adapted to generate masking areas for frames in the stabilized frame sequence based on the object ROIs determined by the object tracking. In addition, the same circuit, a different circuit, or a fourth section of the same or different circuit may be adapted to control the configuration of the circuit(s) or section(s) of circuit(s) that provide the functionality described above.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio and microwave, then the coaxial cable, fiber optic cable, twisted pair, DSL, or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for generating a cinemagraph, comprising:
determining optical flow information for a frame sequence;
performing image stabilization using the optical flow information to produce a stabilized frame sequence;
performing object tracking across the frame sequence using motion vector information to determine an object region of interest (ROI) of an object in each frame in the frame sequence;
generating a masking area for each frame in the stabilized frame sequence based on the object ROI for the frame; and
merging the masking areas and the stabilized frame sequence to generate the cinemagraph.

2. The method of claim 1, wherein the masking area of a given frame is determined by a reference frame object ROI and a current frame object ROI.

3. The method of claim 1, further comprising determining a reference frame object ROI based on the object tracking.

4. The method of claim 1, further comprising segmenting the object ROIs using the motion vector information to only include an area that the object occupies.

5. The method of claim 1, further comprising aligning the object ROIs with the stabilized frame sequence.

6. The method of claim 1, wherein a masking area for a current frame removes the object from the current frame and displays the object from a reference frame, wherein the object that is tracked becomes a static area of the cinemagraph.

7. The method of claim 1, wherein a masking area comprises area of a current frame outside a reference frame object ROI and a current frame object ROI, wherein the masking area displays the reference frame with the exception of the reference frame object ROI and the current frame object ROI such that the object that is tracked becomes a moving area of the cinemagraph.

8. An electronic device configured for generating a cinemagraph, comprising:
a processor;
memory in communication with the processor; and
instructions stored in the memory, the instructions executable by the processor to:
determine optical flow information for a frame sequence;
perform image stabilization using the optical flow information to produce a stabilized frame sequence;
perform object tracking across the frame sequence using motion vector information to determine an object region of interest (ROI) of an object in each frame in the frame sequence;
generate a masking area for each frame in the stabilized frame sequence based on the object ROI for the frame; and
merge the masking areas and the stabilized frame sequence to generate the cinemagraph.

9. The electronic device of claim 8, wherein the masking area of a given frame is determined by a reference frame object ROI and a current frame object ROI.

10. The electronic device of claim 8, further comprising instructions executable to determine a reference frame object ROI based on the object tracking.

11. The electronic device of claim 8, further comprising instructions executable to segment the object ROIs using the motion vector information to only include an area that the object occupies.

12. The electronic device of claim 8, further comprising instructions executable to align the object ROIs with the stabilized frame sequence.

13. The electronic device of claim 8, wherein a masking area for a current frame removes the object from the current frame and displays the object from a reference frame, wherein the object that is tracked becomes a static area of the cinemagraph.

14. The electronic device of claim 8, wherein a masking area comprises area of a current frame outside a reference frame object ROI and a current frame object ROI, wherein the masking area displays the reference frame with the exception of the reference frame object ROI and the current frame object ROI such that the object that is tracked becomes a moving area of the cinemagraph.

15. A computer-program product for generating a cinemagraph, comprising a non-transitory tangible computer-readable medium having instructions thereon, the instructions comprising:
code for causing an electronic device to determine optical flow information for a frame sequence;
code for causing the electronic device to perform image stabilization using the optical flow information to produce a stabilized frame sequence;
code for causing the electronic device to perform object tracking across the frame sequence using motion vector information to determine an object region of interest (ROI) of an object in each frame in the frame sequence;
code for causing the electronic device to generate a masking area for each frame in the stabilized frame sequence based on the object ROI for the frame; and
code for causing the electronic device to merge the masking areas and the stabilized frame sequence to generate the cinemagraph.

16. The computer-program product of claim 15, wherein the masking area of a given frame is determined by a reference frame object ROI and a current frame object ROI.

17. The computer-program product of claim 15, further comprising code for causing the electronic device to segment the object ROIs using the motion vector information to only include an area that the object occupies.

18. The computer-program product of claim 15, further comprising code for causing the electronic device to align the object ROIs with the stabilized frame sequence.

19. The computer-program product of claim 15, wherein a masking area for a current frame removes the object from the current frame and displays the object from a reference frame, wherein the object that is tracked becomes a static area of the cinemagraph.

20. The computer-program product of claim 15, wherein a masking area comprises area of a current frame outside a reference frame object ROI and a current frame object ROI, wherein the masking area displays the reference frame with the exception of the reference frame object ROI and the current frame object ROI such that the object that is tracked becomes a moving area of the cinemagraph.
